(19) United States
(12) Patent Application Publication
(10) Pub. No.: US 2004/0158579 A1
(43) Pub. Date: Aug. 12, 2004

(54) Server side play-list

(76) Inventor: Palamalai Gopalakrishnan, Seattle, WA (US)

Correspondence Address: LEE & HAYES PLLC, 421 W RIVERSIDE AVENUE SUITE 500, SPOKANE, WA, 99201

(21) Appl. No.: 10/365,113

(22) Filed: Feb. 12, 2003

(51) Int. Cl. G06F 17/00

(52) U.S. Cl. 707/104.1

(57) ABSTRACT

The present disclosure relates to a server side play-list that provides functionality to a client device to skip forward, backwards, rewind to various elements in a content that is streamed from the server. The server maintains records of each element that the server streams. For each record of a streamed element, a unique play-list generation identifier value is created and maintained at the server. A client device receives a list of play-list generation identifier values that corresponds to elements received by the client device. The client device identifies elements through the list of play-list generation identifier values. The client device may render a particular element, the desires to skip to another element in the list. Using the play-list generation identifier value of the particular element, and identifying its relationship in a list of received play-list generation identifier values, the client device provides the desired play-list generation identifier value of the element it desires to receive.

### TECHNICAL FIELD

This disclosure relates to server-side play-lists, and more particularly to client-side ability to skip forward, skip backward and rewind completely a server side play-list.

### BACKGROUND

A client computer may request content from a server computer. The server computer either streams the content to the client computer, or allows the client computer to access the content. Content may include digital video, audio, or some other content either from the server or from a storage location (e.g., secure hard disk storage) or broadcast point which the server accesses. Typically the content is sent as a continuous stream to the client computer.

There are various file formats for streaming media content and composite media streams. Advanced systems format (ASF) as defined by the Microsoft Corporation, is an example of such a file format. ASF specifies the way in which multimedia content is stored, streamed, and presented by the tools, servers, and clients of various multimedia vendors. ASF provides a storage and transmission file format that encapsulates multimedia data types. Images, audio, and video as well as embedded text (e.g., URLs), graphic elements, and hyperlinks associated with elements on a Windows Media Player(g) interface are examples of items, or content that may be so encapsulated. Such file formats provide for the synchronization of these objects within a stream.

Regardless of the streaming file format used, a data stream contains a sequence of digital data sets, units, or elements (hereinafter collectively referred to as “elements”). These elements may represent an image, sound, or some other stimuli. A set of elements or a single element may be referred to as content. The client computer renders the elements individually. For example, a client computer may receive a list of individual song element, and each song element is played separate from the other song elements.

The order in which the songs are played is determined by a play-list file or play-list. A play-list may contain information such as whether to play certain pieces of content more than one time, which pieces of content to play, the order in which to play referenced content, and the like. Play-lists may contain references g to one or more media streams and describe how pieces of media are combined. Play-lists do not contain the actual media data, but rather references to the media data. As a result, play-lists are typically small, usually contain only text data, and are generally easy and computationally inexpensive to provide and modify. References to a particular element may appear in many play-lists.

Content that is referenced by a play-list may be stored on a Windows Media® server, a unicast or multicast broadcast that is accessed from a publishing point, on a Web server, on a network share, on a file on a local hard disk drive, and/or the like.

Play-lists have the effect of combining several individual pieces of content into one single complex piece of content, and they are very useful to providers of streaming media. Play-lists allow content providers to combine advertisements with other elements, and build a business based on advertising revenue. Play-lists allow Internet radio stations to create a list of broadcast songs. Play-lists also allow content providers to brand their content by attaching previews or identifiers (e.g., radio station identifiers) before or after the content.

Play-lists may be implemented either on a client or on a server such as a Windows Media® server. When the client implements a play-list, the play-list is typically downloaded from a server such as a Web server, a file server, and/or the like. The client interprets the play-list to present a series of requests to one or more servers to access at least a portion (element) of the content represented in the play-list. A server is generally not aware that the client is requesting content that is referenced in a client-side play-list. This is because use of a client-side play-list is indistinguishable from a client communicating a number of requests to the server to play several different elements of the content one after the other.

Server-side play-lists are maintained by a server and not downloaded to a client. To access the content represented by a server-side play-list file, a client requests for content to be provided from the server. Generally, the only option available to the client is either to receive content or not to receive content. In other words, there may be no functionality in a server-side play-list that allows the client to skip forward to a different element or skip backward to an element that has been played. For example, if a music album is presented to a client, and the client wants to repeat a track from the album and desires to go back to the previous track a server side play-list may not allow such an action.

Server-side play-lists typically are more desirable for content providers, since content providers have greater control over the content (i.e., order of the elements) that is presented to clients. For example, through a server-side play-list, a content provider is able to present advertisement elements that are viewed by the client. Or particular elements, such as a song that the content provider wants to promote, may be presented to the client. In either case, and in other cases using a server-side play-list, the client can not skip over the content that the content provider desires to be presented to the client.

Since play-lists come in different formats, compatibility in certain cases becomes a problem, particularly for client-side play-lists. In other words if a client receives a play-list from one party (e.g., server), and receives the referenced content from another party (e.g., another server), the play-list and reference content may not be compatible with one another. Further if a new version of a play-list is made available, using a client side play-list only allows newer clients that understand the new play-list version to use it. All clients will be required to be up to date with the new playlist. Server-side playlists allow playlist upgrades that may be used by all clients.

A server-side play-list further assures compatibility with the reference content, since both the play-list and the reference content come from the same server. However, as discussed above, there is limited functionality in a server-side play-list that allows the client to skip forward to a different element or skip backward to an element that has been played. If the client wants to repeat a track (e.g., a favorite track in the album), the client is precluded from going back and replaying the particular element.

### SUMMARY

The systems and methods described herein include a server computer that receives requests from a client device for content that includes one or more elements. The server computer streams the elements to the client device, and identifies each element as it is streamed. A list, called the receding play-list entry list, is created as to all the elements that are sent to client device. A play-list at the server computer lists an order that the elements are played or rendered.

In certain embodiments an identifier value, called a play-list generation id, is assigned to each element, where the identifier value maps an order in which an element is sent from the server computer.

In particular embodiments, the client device provides requests to skip forward or backward by identifying a particular element through the play-list generation identifier value associated with the element.

### BRIEF DESCRIPTION OF THE DRAWINGS

A more complete understanding of exemplary methods and arrangements of the present invention may be had by reference to the following detailed description when taken in conjunction with the accompanying drawings wherein:

FIG. 1 is a block diagram illustrating system to manage and stream multimedia content.

FIG. 2A is a block diagram illustrating a logical data-path from a single source that provides content elements to a client device.

FIG. 2B is a block diagram illustrating various data-paths from multiple sources that provide content elements to a client device.

FIG. 3 is a block diagram illustrating an architecture that defines a media element.

FIG. 4 is a flowchart illustrating the creation of data-paths as a server sends elements to a client device.

FIG. 5 is a block diagram illustrating how elements are tracked by a wrapper play-list multiplexor.

FIG. 6 is a block diagram illustrating a table that describes specific information of each element as seen by a wrapper play-list mux.

FIG. 7 is a block diagram illustrating a receding information list play-list entries.

FIG. 8 is a block diagram illustrating an exemplary architecture for a server and/or client computing device.

### DETAILED DESCRIPTION

Exemplary System for Play-list and Streaming Media Management

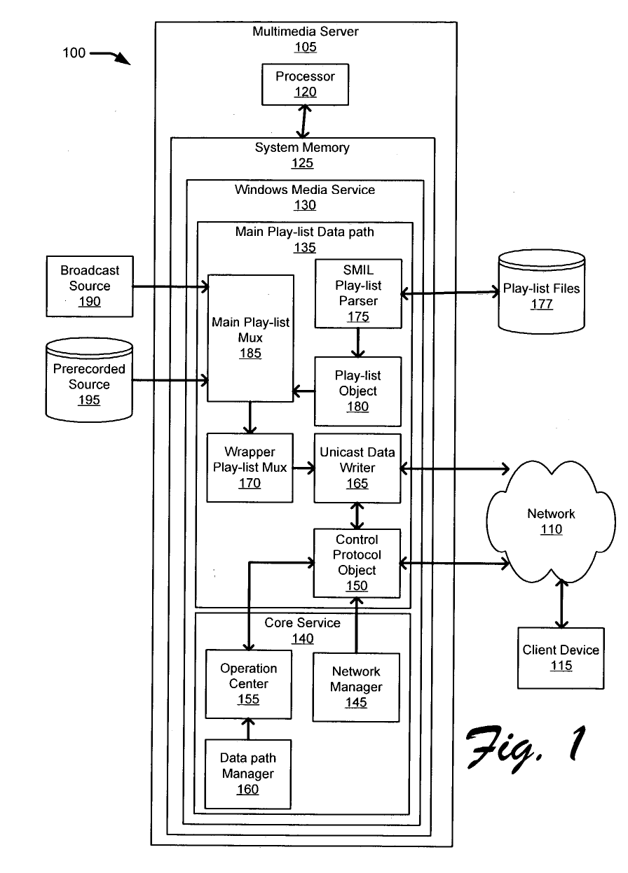

FIG. 1 is a block diagram that shows aspects of an exemplary system 100 to dynamically manage and stream multimedia content. The system 100 includes a multimedia server computer 105. Multimedia server computer 105 may be a general purpose computer, a server computer, a Windows Media® server, and/or the like.

The multimedia server computer 105 is coupled via a network 110 to client device 115. Client device 115 may be a personal computer, a server computer, and/or the like. Further, additional client devices may also be coupled to network 110, and to multimedia server computer 105. The network 110 can be any type of communication network such as the Internet, an organizational intranet, a local-area network (LAN), private wide-area networks, and/or the like.

The multimedia server computer 105 includes a processor 120 that is coupled to a system memory 125. The system memory 125 includes any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory card, a CD-ROM, and/or the like.

The processor 120 is configured to fetch and execute computer program instructions from program modules stored in system memory 125. System memory 125 includes application programs which in particular include windows media service 130. Windows media service 130 accepts requests for a play-list from one or more client devices, such as client device 115. When client device 115 requests a play-list to be played, a main play-list data path 135 is initiated. Windows media service 130 includes a core service 140 functional block that contains functional modules which operate independent of other functions of windows media service 130 (i.e., core service 140 performs in the background as part of continued operations of multimedia server 105).

Core service 130 includes a network manager 145 that is instructed by the operating system (as requested by client device 115) of the multimedia server 105 to create a control protocol object 150. Once control protocol object 150 is created, it communicates with an operation center 155 of core service 140. Control protocol object further advises the client device that a play-list is available. Operational center 155 is responsible for creating data paths as initiated by a data path manager 160.

A unicast data writer 165 sends data stream (i.e., elements in a play-list) to client device 115. Wrapper play-list mux 170 tracks elements that have been played. Tracking is performed for subsequent replay purposes. A SMIL play-list parser 175 accesses play-list files from play-list file storage 177, and creates a play-list object 180. Main play-list mux 185 receives the play-list object 180 and creates input data paths based on elements from either a broadcast source 190 and or prerecorded source 195.

Elements may be received by windows media service 130 from various sources and arrive through the appropriate input data paths. Wrapper play-list mux 185 keeps a list, called a receding play-list entry list, of the elements played in the play-list

As discussed, elements may be received from various sources and paths. In this example, an element may come from a prerecorded source such as prerecord source 195, where prerecorded source 195 may be a secure hard disk. An element may also come from a live broadcast source such as broadcast source 190 where the live broadcast source may be described by a broadcast publishing point identifier. The stream of elements may include a combination of elements from various sources. For example, live broadcast elements may come from broadcast source 190, and advertising elements from prerecorded source 195 may be interjected between live broadcast elements from broadcast source 190.

Play-list data format can be one of any number of different data file formats, including the synchronized multimedia integration language (SMIL). SMIL is an extension of the World Wide Web consortium (W3C) standard extensible markup language (XML) file format. SMIL provides syntax and structure to define both high-level instructions and data corresponding to the content referenced by a play-list. An example of a SMIL play-list is as follows.

<smil>

<media src=“content_clip1.wmv”/>
<media role=“Advertisement” noSkip=“TRUE” src=“encoder_ad.wmv”/>
<media src=“content_clip2.wmv”/>

</smil>

In this particular play-list, elements are defined as Windows Media® Video (wmv) format. A first video element is followed by a second advertisement element that is followed by a third video element. A client device, such as client device 115, using this play-list views the three elements consecutively. The second element has a particular instruction to prevent client device 115 from skipping the viewing of the second element which is an advertisement.

Client device 115 generally requests to receive content from the multimedia server 105. Client device 115 may request for a specific play-list or be provided a particular play-list from by multimedia server 115. The play-list is resident at multimedia server 115, however, the client device 115 is able to access the play-list and manipulate the play-list by providing commands to multimedia server 105.

Datapath Structure

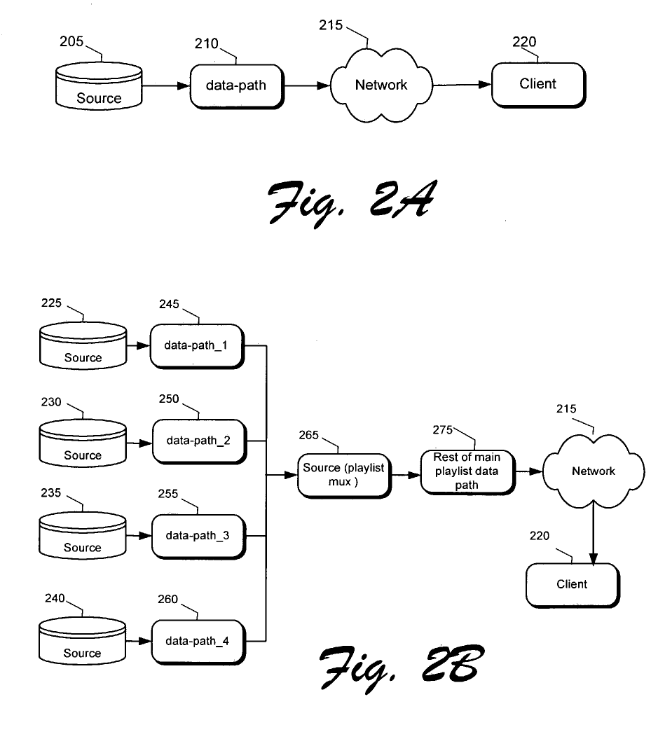

FIG. 2A illustrates a logical data-path from a single source that provides content elements to a client device. Source 205 contains content that may be made up of one or more elements. The elements of source 205 are defined as inputs by a data-path 210 that describes source 205 as the origin of the elements. Source 205 may be a physically separate entity such as a secure hard disk, a Windows Media encoder or another Windows Media Server.

Content of source 205 is delivered through a network 215 to client device 220. The network 215 can be any type of communication network such as the Internet, an organizational intranet, a local-area network (LAN), private wide-area networks, and/or the like. A server computer, such as multimedia server computer 105 of FIG. 1, either determines data-path 210 or receives information regarding data-path 210, prior to the content of source 205 being delivered through network 215. With source 205 acting as a source to network 205, content may be delivered through network 215 using one of various protocols, including transmission control protocol/internet protocol (TCP/IP).

FIG. 2B illustrates various data-paths from multiple sources that provide content elements to a client device. Various elements making up content may either be logically or physically defined into separate sources. In this example, a particular element “originates” or is an input from source 225. Other elements respectively originate or are inputted from source 230, source 235, and source 240. It is contemplated that physically the elements originate from the same location, however logically each element will be viewed as originating from different sources. In this example, the source or input of each element is defined as follows. Element of source 225 is defined as an input by data-path_1 245. Element of source 230 is defined as an input by data-path_2 250. Element of source 235 is defined as an input by data-path_3 255. Element of source 240 is defined as an input by data-path_4 260.

The elements of sources 225, 230, 235, and 240 are received at source 265. Source 265 effectively acts as a “sink” to receive elements, and also acts as a “source” that distributes elements. In this example, source 265 distributes elements through the main play-list data path 275. With source 265 acting as a source, elements may be delivered through network 215 using one of various protocols, including TCP/IP. Client device 220 receives the elements of source 265.

Exemplary Software Architecture for Media Content

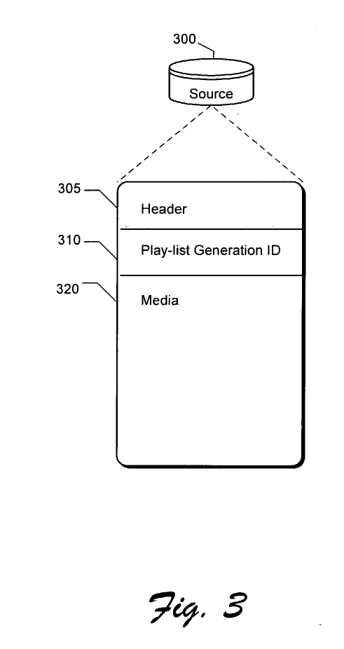

FIG. 3 illustrates an architecture that defines a media element. Source 300 includes a specific and discrete media element. Source 300, more specifically the element of source 300, is described and identified by a specific format. The format includes distinct sections of information that describe and distinguish the element of source 300.

A header 305 provides limited information describing the element of source 300. Header 305 may include information describing the format type of the element. Header 305 may include an indication such as a flag or signal indicates a new element (i.e., a change of elements at the client device). Or in the case when content is first received and elements are rendered, the flag or signal indicates the beginning of receipt of content and elements. Header 305 may also include information that is conveyed to the client device as to whether skipping backward or forward, and by what degree, is possible from the particular element. For example, in a ten element play-list, the first element allows for skipping forward to nine or less elements, but does not allow skipping backwards, since there is no preceding element. For the third element in the play-list, actions are possible to skip two elements backwards to the first element, to skip seven elements forward to the tenth element, and any backward or forward skipping commands to intermediate elements. Header 305 may be received or read separate from the other sections of the element of source 300.

The element of source 300 includes a play-list generation identifier (ID) 310. Play-list generation ID 310 is a value that is incremented each time an element is sent out by the server. A particular element may be sent for multiple occurrences. For example, the element of source 300 may be the first element sent, and have an initial play-list generation ID 310 value of “one.” The element of source 300 may later be sent out as the 29^{th} element, and the play-list generation ID 310 will have the value of “29.” An exemplary method of incrementing the value of play-list generation ID is to increment the current value each time a header flag or signal is encountered by the server. This would be indicative of sending out an element, regardless of the number of times the element has been sent.

Actual media of the element of source 300 is represented by media 320. Media 320 is made of a file that may be a digital data set or unit, that is defined by one of several formats that include “wmv” files, “asf” files, and similar media and/or multimedia files. Media 320 is the portion of the element of source 300 that is actually rendered at the client device.

Operation—Receiving Elements

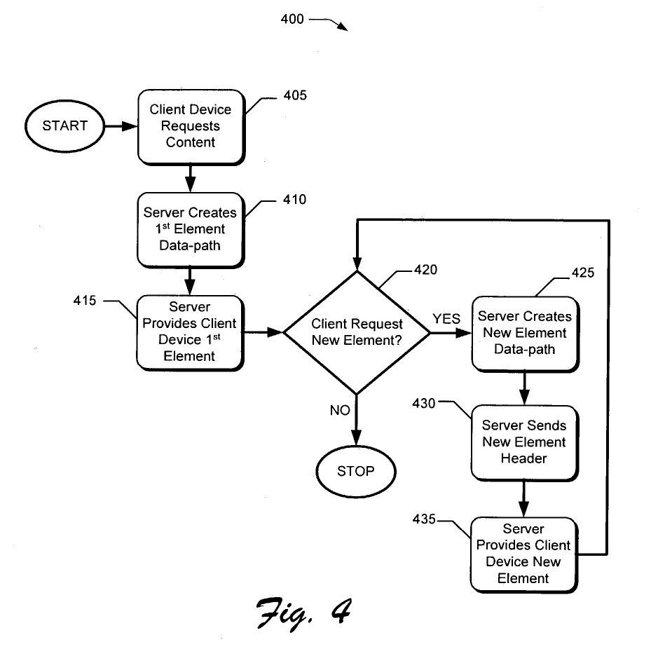

FIG. 4 is a flowchart 400 illustrating the creation of data-paths as a server sends elements to a client device.

At block 405, a client device desires to receive content from a server such as multimedia server 105 of FIG. 1. The server begins to stream the first element of the content to the client device. The first element that is sent to the client device is the first element of a play-list.

At block 410, as the server receives the request for content, a data-path is created for the first element. The data-path information may be stored at the server for later reference; however, one principle function of the data-path is to allow elements from particular sources to be streamed to client devices such as client device 115 of FIG. 1.

At block 415, the server sends the first element of the content to the client device. The first element includes header information describing the type or format of the element. The client device completes rendering or playing of the first element.

At block 420, a decision is made as to whether the client device desires to receive a new element from the server. A “new” element may be an element that has been received by the client device. For example, if the client device desires to skip back to a particular element, the client device requests for the particular element from the server. Each time a request is made for an element, a new data-path is defined regardless of whether the element has been previously requested.

At block 425, once the first element is sent by the server, the server begins creating a new data-path for the succeeding element. In this example, block 425 follows a decision by the client device to receive a new element. In other embodiments, block 425 is performed regardless of whether a new element is requested. The new data-path may be stored at the server for later reference.

At block 430, prior to sending the portion of the element used in rendering to the client, the header associated with the element is sent to the client device. The header provides information to the client device that a new element is being sent from the server. The header also informs the client device the type or format of the new element. The header information allows the client device, by knowing a change in elements and the format of the next element, to be ready to receive the new element. In addition, the header as described above, informs the client device as to the ability to skip forward and/or backwards from the particular element.

At block 435, the server provides the client device with a new element for rendering. After the current element is rendered or played, the client device decides whether to receive additional elements by performing block 420.

Operation—Wrapper Play-list Multiplexor

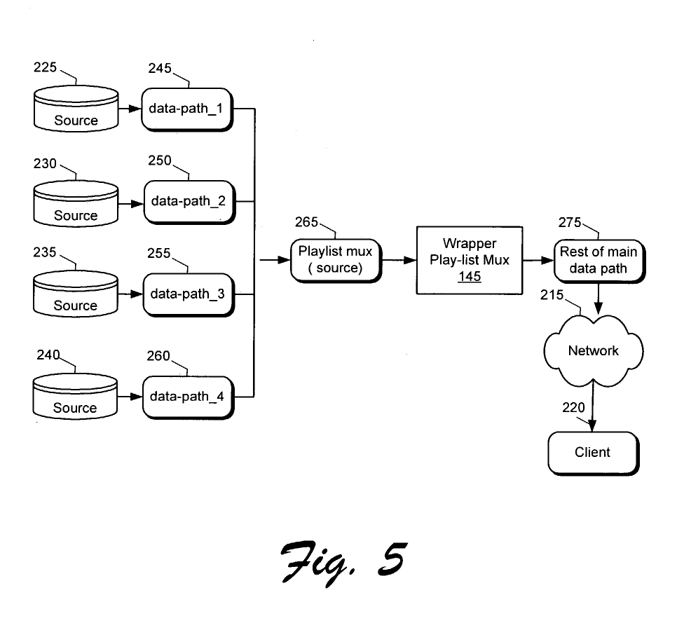

FIG. 5 illustrates how elements are tracked by a wrapper play-list mux. As elements are streamed to a client device, the wrapper play-list mux 145, as previously described, keeps track of the data-paths 245, 250, 255, and 260 that are created as the respective elements are streamed to a client device. In this example, the client device is client 220 which receives elements from source 265 by way of network 215.

Wrapper play-list mux 145 is set up to be in the flow of the elements as the elements are streamed to source 265 and eventually to client 220. Therefore wrapper play-list mux 145 is able to keep track of the order in which the elements are streamed. The order of streaming of the elements contained in sources 225, 230, 235, and 240 may be in any particular order. The information as to the order that the elements are streamed may be kept as a linked list of the data-paths of the respective sources. The linked list is stored in wrapper play-list mux 145.

Wrapper play-list mux 145 further is configured to create a receding information list that includes the separate entries of each element that are streamed to client 220.

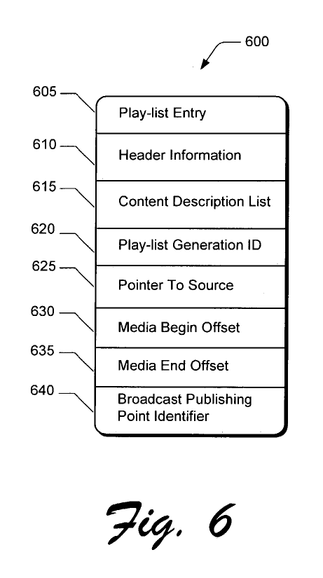

FIG. 6 illustrates a table 600 that describes specific information of each element that is seen by wrapper play-list mux 145. Tables are created for each element as the elements are streamed to the client device. Tables may be stored in system memory 125 of multimedia server 105 illustrated in FIG. 1, and accessed by play-list mux 145. An element may be identified by its entry in the play-list. For example, the first element in the play-list is identified as a play-list entry of “1.” It follows that the Nth element in the play-list is identified as play-list entry of “N.” Play-list entry 605 field identifies the play-list entry for each element in the play-list.

The table further provides header information 610, the same header information discussed above. A content description list 615 may be included to provide information regarding the element that is not provided by other fields such as header information 610.

As discussed, a play-list generation ID is created each time an element is sent by the server. The value for the play-list generation ID is incremented each time an element is sent. Therefore, an absolute value is created as to the number of elements sent by the server. A field play-list generation ID 620 is provided that identifies the particular play-list generation ID value.

The table also provides a field for each element that describes a pointer to source 625. The pointer to source field 625 directs the server to the origin of the particular element. Since elements may be streamed to a client device more than once, a pointer to the source avoids the need to identify the elements by name. In other words, the pointer to source field 625 directs streaming from the source without having to identify the source or element by name.

If a particular element is streamed from the server for a multiple number of times, it is foreseen that multiple table entries will exist that have the same values, except for the play-list generation ID values. In other words, there can be multiple tables describing the same element, except with different play-list generation ID values. The different play-list generation ID values are indicative of the different occasions in which the particular element was streamed from the server.

Table 600 includes fields media begin offset 630 and media end offset 635. For a particular element or media represented, media begin offset 630 flags the beginning of the element, and media end offset flags the end of the element. Table 600 further includes a broadcast publishing point identifier 640 that is used to identify whether the element originates from a broadcast point. A broadcast may be a play-list that defines multiple elements. The broadcast publishing point identifier 640 allows the broadcast element to be treated as one element not multiple elements.

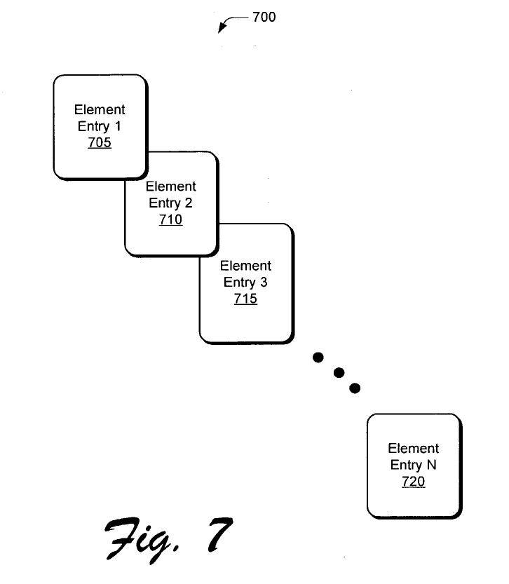

Referring now to FIG. 7, illustrated is a receding information list 700 of play-list entry tables. In this example, only one client provides a request to the server. In other cases, multiple clients may request elements at the same time. Separate tables are created for each entry that is received as discussed above. FIG. 7 illustrates an order of the element entries. In this example, an “element entry 1” 705 is the first received element. As the first received element, “element entry 1” 705 has a play-list generation ID of “1.” “Element entry 1” 705 is followed by “element entry 2” 710 with a play-list generation ID of “2,” which is followed by “element entry 3” 715 with a play-list generation ID of “3.” The last element entry is “element entry N” 720 having a play-list generation ID of “N.”

Referring back to FIG. 6, media begin offset 630 and media end offset 635 are used for rewinding. Referring once again to FIG. 7, each of the element entries have identifying fields media begin offset 630 and media end offset 635. As an example, if “element entry 3” 715 is being played and rewind is initiated, media offset begin 630 field is skipped to; this rewinds to the beginning of “element entry 3” 715. Then further rewind looks to the media end offset 635 field of “element entry 2” 710. Further rewind looks to the media begin offset 630 field of “element entry 2” 715, and so on.

Operation—Pause and Skip

As the client device receives elements, the element entry tables are created as illustrated in FIG. 7. If the client device continues without interruption of receiving and rendering of elements, all the element entry tables up to “element entry N” 720 will be created and stored in wrapper play-list mux 145.

The client device may decide to pause on a particular element, for example the client device may decide to pause at “element entry 3” 715. The client device instructs the server, and more specifically informs wrapper play-list mux 145 to pause.

Further, the client device might wish to skip back to a particular element. In this example, suppose the client device desires to skip back to “element entry 2” 710 when it is currently receiving “element entry 3” 715. The client device sends a command to the server to skip backwards by one entry. At this instance, the play-list generation ID is “3” which describes “element entry 3” 715. At the wrapper play-list mux 145 streaming of the instant element is paused. A new data-path is created that logically describes a new input that is used to stream the previous element, that is described in “element entry 2” 710.

The wrapper play-list mux 145 determines what particular element is actually being rendered at the client device. The particular element has a particular element entry table that includes a particular play-list generation ID value. The receding play-list entry list is searched for the preceding element entry.

The wrapper play-list mux 145 looks at the preceding play-list generation ID value, determines the corresponding element entry, and using the pointer to source value included in the element entry determines the source of element. With the information regarding the source, the element in the source can now be streamed to the client device by creating a new data-path by the wrapper play-list mux. In this particular case, since a skip backwards was requested, the previous element is re-streamed to the client device.

In certain cases, a client device may decide to skip forward to a particular element. Play-lists, such as play-lists written in SMIL, allow skipping forward. As discussed, a play-list provides an ordering of elements. If a client device provides a command to skip forward, the server looks at the play-list, determines which element is being streamed to the client device, interprets the skip forward command from the client device (e.g., skip “2” elements), and goes to the element that corresponds to the command (i.e., goes to the element that succeeds “2” places from the current element).

The wrapper play-list mux 145 tracks play-list generation ID values. Multiple client devices may make use of the same play-list, and client devices receive unique orders of play-list generation ID values, since client devices will provide different requests (e.g., skip forward, skip backward, continue play without interruption). The server, however, tracks elements as they are streamed to clients, incrementing play-list generation ID values each time an element is streamed. Although clients receive different orders of play-list generation ID values, since the wrapper play-list mux 145 keeps track of each play-list generation ID value, knowing the particular play-list generation ID value, the element and the source of the element is identified through the element entries created at the wrapper play-list mux 145.

Operation—Multiple Sources/Servers

In certain cases a server play-list resides on the server and references elements that are located at different servers or devices. This play-list is referred to as a distribution play-list. An example includes having elements stored locally at the server in which the play-list resides, and other elements residing at different servers or devices. If all elements are local, the data-paths can be created identifying the source as a local source. If an element is stored in a different server or device, an intermediate data-path may be created to refer to the different server or device. The intermediate data-path may be referenced as an extension to a local data-path defined at the local server. It is also contemplated that intermediate data-paths may have intermediate data-paths of their own. In other words, various layers of data-paths may exist.

A play-list wrapper mux receives each element and tracks the data-paths that each element is sent, and assigns a unique play-list generation ID values. Through the mapping of play-list generation ID values to sources at the play-list wrapper, a client device is able to provide a particular play-list generation ID value and the play-list wrapper mux is able to trace the source that corresponds to the particular play-list generation ID value.

Exemplary Server and/or Client Computer

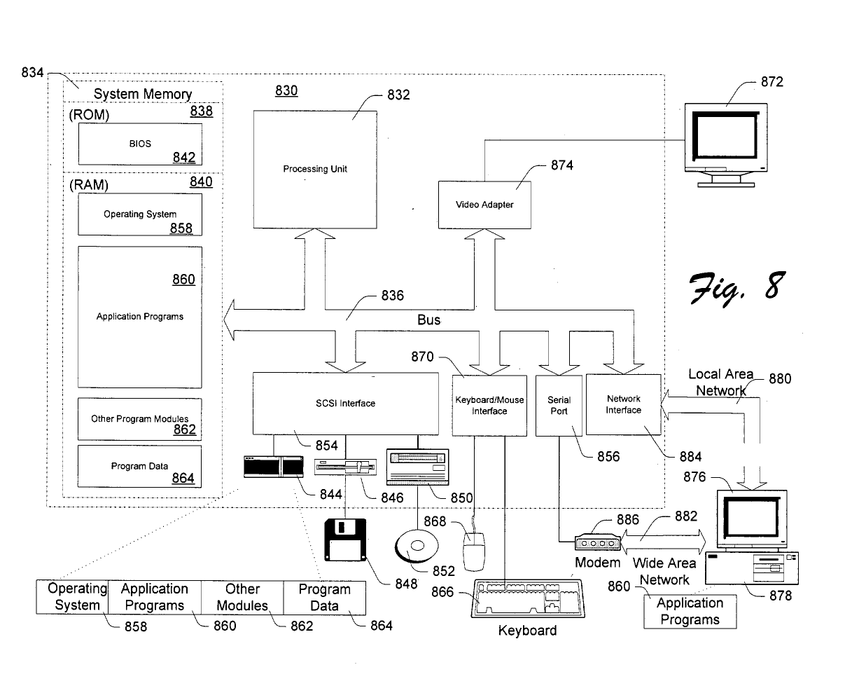

FIG. 8 shows a general example of a computer 830 that is used as a server and/or client device in accordance with the subject matter. Computer 830 is shown as an example of a computer that can perform the functions of a multimedia client/server computer 110 of FIG. 1. Computer 830 includes one or more processors or processing units 832, a system memory 834, and a bus 836 that couples various system components including the system memory 834 to processors 832.

The bus 836 represents one or more of any of several types of bus structures, including a memory bus or memory controller, a peripheral bus, an accelerated graphics port, and a processor or local bus using any of a variety of bus architectures. The system memory includes read only memory (ROM) 838 and random access memory (RAM) 840. A basic input/output system (BIOS) 842, containing the basic routines that help to transfer information between elements within computer 830, such as during start-up, is stored in ROM 838. Computer 830 further includes a hard disk drive 844 for reading from and writing to a hard disk, not shown, a magnetic disk drive 846 for reading from and writing to a removable magnetic disk 848, and an optical disk drive 850 for reading from or writing to a removable optical disk 852 such as a CD ROM or other optical media. The hard disk drive 844, magnetic disk drive 846, and optical disk drive 850 are connected to the bus 836 by an SCSI interface 854 or some other appropriate interface. The drives and their associated computer-readable media provide nonvolatile storage of computer readable instructions, data structures, program modules and other data for computer 830.

Although the exemplary environment described herein employs a hard disk, a removable magnetic disk 848 and a removable optical disk 852, it should be appreciated by those skilled in the art that other types of computer readable media which can store data that is accessible by a computer, such as magnetic cassettes, flash memory cards, digital video disks, random access memories (RAMs) read only memories (ROM), and the like, may also be used in the exemplary operating environment.

A number of program modules may be stored on the hard disk, magnetic disk 848, optical disk 852, ROM 838, or RAM 840, including an operating system 858, one or more application programs 860, other program modules 862, and program data 864.

A user may enter commands and information into computer 830 through input devices such as keyboard 866 and pointing device 868. Other input devices (not shown) may include a microphone, joystick, game pad, satellite dish, scanner, or the like. These and other input devices are connected to the processing unit 832 through interface 870 that is coupled to bus 836. Monitor 872 or other type of display device is also connected to bus 836 via an interface, such as video adapter 874.

Computer 830 operates in a networked environment using logical connections to one or more remote computers, such as a remote computer 876. The remote computer 876 may be another personal computer, a server, a router, a network PC, a peer device or other common network node, and typically includes many or all of the elements described above relative to computer 830, although only a memory storage device 878 has been illustrated in FIG. 8. Computer 876 is shown as an example of a computer that can perform the functions of a client computer 838 of FIG. 8. The logical connections depicted in FIG. 8 include a local area network (LAN) 880 and a wide area network (WAN) 882. Such networking environments are commonplace in offices, enterprise-wide computer networks, intranets, and the Internet.

When used in a LAN networking environment, computer 830 is connected to the local network 880 through-a network interface or adapter 884. When used in a WAN networking environment, computer 830 typically includes a modem 886 or other means for establishing communications over the wide area network 882, such as the Internet. The modem 886, which may be internal or external, is connected to the bus 836 via a serial port interface 856. In a networked environment, program modules depicted relative to the personal computer 830, or portions thereof, may be stored in the remote memory storage device. It will be appreciated that the network connections shown are exemplary and other means of establishing a communications link between the computers may be used.

Generally, the data processors of computer 830 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory.

The subject matter described herein includes these and other various types of computer-readable storage media when such media contain instructions or programs for implementing the steps described below in reference to FIG. 8 in conjunction with a microprocessor or other data processor.

The subject matter also includes the computer itself when programmed according to the methods and techniques described below. Furthermore, certain sub-components of the computer may be programmed to perform the functions and steps described below. The subject matter includes such sub-components when they are programmed as described. In addition, the subject matter described herein includes data structures, described below, as embodied on various types of memory media.

For purposes of illustration, data, programs and other executable program components, such as the operating system are illustrated herein as discrete blocks, although it is recognized that such programs and components reside at various times in different storage components of the computer, and are executed by the data processor(s) of the computer.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
receiving a request from a client device for content;
streaming each element of the content to the client device;
identifying each element of the content as each element is streamed to the client device; and
creating a list of all elements sent to the client device.

2. The method of claim 1 further comprising receiving a request from the client device to receive an element from the list.

3. The method of claim 2 wherein the element is from a broadcast point.

4. The method of claim 2 wherein the element is identified by a broadcast publishing point identifier value.

5. The method of claim 1 wherein the identifying each element is performed by listing each element in a receding play-list entry list.

6. The method of claim 5 wherein the client device requests to receive an element by identifying a generation identifier value to the element.

7. The method of claim 1 wherein the streaming is performed through logically defined data-paths.

8. The method of claim 7 wherein each data-path leads to a particular source that defines the origin of a particular element.

9. The method of claim 1 wherein each element includes a header that comprises a flag to indicate a new element that is streamed to client device.

10. The method of claim 1 wherein each element includes a header that comprises information regarding the format of the element.

11. The method of claim 1 wherein the elements are streamed from a device other than the server and defined by the server through unique data-paths.

12. A method comprising:
creating a play-list based on the origin of entries;
receiving the play-list at a client device; and
skipping forward or backward over the entries defined by the play-list.

13. The method of claim 12 further comprising rewinding entries defined by the playlist.

14. The method of claim 12 wherein the entries originate from the same source.

15. The method of claim 12 wherein the entries originate from different sources.

16. A method comprising:
receiving a request from a client device for content;
creating a data-path for a first element to be streamed to the client device, wherein the data-path defines a particular source to the element;
streaming the first element to the client device;
determining if the client device desires to receive a succeeding element of the content;
creating a data-path for the succeeding element wherein the data-path defines a particular source to the succeeding element; and
sending the element to the client device, if the client device desires receipt.

17. The method of claim 16 wherein the elements comprise header information that indicates a change of elements to the client device.

18. A method comprising:
requesting content to be sent;
receiving elements of the content, wherein each element comprises a unique generation identifier value; and
storing a list of elements and their unique generation identifier values as they are received.

19. The method of claim 18 wherein one of the elements originates from a broadcast point and contains multiple elements, further comprising identifying the one of the elements originating from the broadcast point and treating it as a single element.

20. The method of claim 18 wherein the one of the elements originating from the broadcast point is identified by a broadcast publishing point identifier value.

21. The method of claim of claim 18 wherein the client device refers to a play-list at the server.

22. The method of claim 18 wherein the client device skips backward on the play-list.

23. The method of claim 18 wherein the client device skips forward on the play-list.

24. The method of claim 18 wherein the client device rewinds elements on the play-list.

25. The method of claim 18 further comprising requesting to receive a received element on the list based on the received element's unique generation identifier value.

26. The method of claim 18 wherein the client device refers to a play-list on the server to request a subsequent element in the play-list that has not been received.

27. One or more computer-readable media containing computer program instructions for providing content to a client device, the computer program instructions comprising instructions for:
receiving a request for content, wherein the content comprises elements;
associating the elements with a play-list;
associating each element with a unique generation identifier value;
streaming the elements to the client device; and
tracking the streamed elements by their unique generation identifier values.

28. One or more computer-readable media containing computer program instructions for receiving content by a client device, the computer program instructions comprising instructions for:
requesting content from a server, wherein the content comprises elements;
receiving the elements, each element being identified by a unique generation identifier value; and
requesting the received elements by identifying the unique generation identifier values of the elements.

29. A computer-readable medium having stored thereon a data-structure comprising:
a first data field functioning to signal a change of elements;
a second data field containing a unique play-list generation identifier value; and
a third data field containing the element.

30. A computer-readable medium having stored thereon a data-structure comprising:
a first data field containing play-list entry information;
a second data field containing header information;
a third data field containing information describing content;
a fourth data field containing a unique play-list generation identifier value;
a fifth data field containing a pointer to a source of an element containing the element;
a sixth data field containing a media begin offset describing the element;
a seventh data field containing a media end offset describing the element; and
an eighth data field containing a publishing point identifier.

31. A server including a processor configured to perform one or more operations comprising:
receiving a request from a client device for content, the content contains one or more elements;
identifying a logical source of each element;
creating a logical data-path from the logical source of each element in order to stream each element to the client device;
streaming the elements to the client device; and
maintaining a mapping of each element that is streamed to the client device.

32. The server of claim 31 wherein a play-list defines the order of the elements of the content.

33. The server of claim 31 further comprising:
generating a unique identifier value associated with each element that is streamed to the client.

34. The server of claim 31 further comprising:
generating a unique identifier value associated with each element and
storing the unique identifier values as part of the mapping of each element that is streamed to the client device.

35. A client device including a processor configured to perform one or more operations comprising:
requesting content from a server wherein the content comprises elements;
instructing a play-list resident at the server, wherein instructing the play-list allows the server to stream elements to the client device; and
maintaining a list of unique generation identifier values that associate elements that are received.

36. The client device of claim 35 further comprising:
requesting a received element from the server by identifying the unique generation identifier value to the server.

37. The client device of claim 35 further comprising:
requesting an element in the play-list that has not been received.
